(19) United States
(12) Patent Application Publication
(10) Pub. No.: US 2024/0282224 A1
(43) Pub. Date: Aug. 22, 2024

(54) LABEL SUPPORT

(71) Applicant: PHOENIX CONTACT GMBH & CO. KG, Blomberg (DE)

(72) Inventors: Patrick OSTER, Lemgo (DE); Manuela PAUS, Muenster (DE); Michael PETER, Lage (DE)

(21) Appl. No.: 18/572,217

(22) PCT Filed: May 16, 2022
(86) PCT No.: PCT/EP2022/063163

§ 371 Date: Dec. 20, 2023

(30) Foreign Application Priority Data
Jun. 24, 2021 (DE) 10 2021 116 336.6

(51) Int. Cl. G09F 3/20; G09F 3/02; G09F 3/10; G09F 3/16

(52) U.S. Cl. CPC G09F 3/205; G09F 3/10; G09F 3/16; G09F 2003/0251

(57) ABSTRACT

A label support includes a holding body for holding a label, which is arranged thereon, on an object to be labeled, the holding body having at least one transparent section for arranging a label. The at least one transparent section includes a plastic that contactlessly detectable in an inductive manner.

### CROSS-REFERENCE TO PRIOR APPLICATIONS

This application is a U.S. National Phase application under 35 U.S.C. § 371 of International Application No. PCT/EP2022/063163, filed on May 16, 2022, and claims benefit to German Patent Application No. DE 10 2021 116 336.6, filed on Jun. 24, 2021. The International Application was published in German on Dec. 29, 2022 as WO/2022/268410 under PCT Article 21(2).

### FIELD

The invention relates to a label support. The invention also relates to apparatuses or objects having a label support formed according to the invention.

### BACKGROUND

Label supports of the type in question are known in many embodiments and serve in particular to label objects in order to be able to distinguish them from one another or to identify them, for example. Thus, label supports are found in many areas—for example, in industrial companies or research areas.

Label supports of the type in question generally have served the object of holding a label on an object, such as an apparatus or individual parts. In this context, label supports of the type in question are widely used in the industrial sector—for example, for labeling production means. They are commonly used, inter alia, in switching cabinets for labeling cables or switching equipment.

The labels attached to a label support of the type in question can therefore be implemented in many ways and can be designed, for example, as color marking, designation, numbers, symbols, characters, graphics, coding, and the like, as well as a combination of different label types.

Particularly in sensitive areas, where there is a need for increased hygiene or to avoid contamination of a product or production material with foreign bodies, there are also increased environmental requirements for the objects located in such areas. This also includes the aforementioned label supports. For example, they are subject to very stringent requirements in the food sector to prevent contamination of food products with unwanted foreign bodies.

Such foreign bodies include, for example, label supports or fragments of label supports which can become detached from an object and enter a food due to external forces or as a result of wear and tear.

To prevent such a contaminated production material or food from being sold on the market, it is necessary to detect and reject foreign bodies located therein at an early stage. One difficulty here is that the unwanted foreign bodies often cannot be detected optically by an optical sensor or visually by a person. It is therefore necessary to be able to reliably detect such foreign bodies even if they are not, or not fully, optically detectable.

To protect a label from external influences, e.g., due to environmental influences or stresses, it is known to provide a transparent section on a relevant label support to which a corresponding label can be attached in order to cover it, for example, with this transparent section.

For this reason, relevant label supports having a holding body for holding a label, which is arranged thereon, on an object to be labeled are known, wherein the holding body has at least one transparent section for arranging a label to protect it from external influences. They are known, for example, from DE102013113328, DE102009014694, DE102019105520, DE102019105526, DE102013109837.

Particularly in the food industry, because of the aforementioned problems, opaque label supports are used which do not have a transparent section.

### SUMMARY

In an embodiment, the present invention provides a label support, comprising: a holding body configured to hold a label, which is arranged thereon, on an object to be labeled, the holding body comprising at least one transparent section configured to arrange a label, wherein the at least one transparent section comprises a plastic that contactlessly detectable in an inductive manner.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a first exemplary embodiment of a label support according to the invention, the holding body of which is formed by a film body having an upper part and a lower part, in a perspectival view and in a schematic representation, wherein the parts of the label support are shown at a distance from one another,

FIG. 2 shows the exemplary embodiment of a label support according to the invention of FIG. 1 in the same view and representation as in FIG. 1, wherein the individual layers of the film body are closer to one another,

FIG. 3 shows a second exemplary embodiment of a label support according to the invention, in which the upper part is formed from a film body, and the lower part is formed from an extruded body, in otherwise the same view and representation as the exemplary embodiment shown in FIG. 1,

FIG. 4 shows a third exemplary embodiment of a label support according to the invention in a schematic end view in a holding state on a cylindrical object to be labeled, in which the upper part and the lower part of the holding body are formed from a round body held by means of holding means on an object to be labeled, wherein a transparent layer covers the label attached to the upper part as a coating,

FIG. 5 shows a fourth exemplary embodiment of a label support according to the invention in a schematic end view in a holding state on a cylindrical object to be labeled, in which the holding body is formed from a film body which is arranged on a cylindrical object, wherein the label is arranged on a side, facing away from the object to be labeled, of the body to be labeled,

FIG. 6 shows a fifth exemplary embodiment of a label support according to the invention in a schematic end view in a holding state on a cylindrical object to be labeled, in which the holding body is formed from a film body, wherein the label is arranged on a side, facing the object to be labeled, of the body to be labeled,

FIG. 7 a sixth exemplary embodiment of a label support according to the invention in a schematic end view in a holding state on a cylindrical object to be labeled, in which a section of the free end of the upper part overlaps a section of the further free end of the lower part in sections in a holding state in which said label support is attached to the object to be labeled,

FIG. 8 shows the sixth exemplary embodiment of a label support according to the invention in a longitudinal extension in a schematic end view,

FIG. 9 shows a seventh exemplary embodiment of a label support according to the invention, the holding body of which is formed with an upper part and a lower part which are folded on a folding line in a connecting region and face one another in a perspectival view and in a schematic representation analogous to FIG. 1,

FIG. 10 shows an eighth exemplary embodiment of a label support according to the invention in a holding state in which it is arranged on a container in a side view and in a schematic representation analogous to FIG. 1,

FIG. 11 shows an exemplary embodiment of a production system with a detection unit for detecting a label support according to the invention or a fragment thereof, which is arranged on a production means, in a schematic representation and in a side view, in which the parts/production means are arranged in a row with respect to one another in an alignment direction.

### DETAILED DESCRIPTION

In an embodiment, the present invention provides a label support having a transparent section for attaching a label, wherein the label support or a fragment detached therefrom can also be detected in a state in which said label support or fragment is located in a non-visible region or is concealed or covered (e.g., by further elements).

Such a configuration can occur, for example, if the label support or a fragment thereof inadvertently enters and mixes with a production material, whereby it can be concealed.

In an embodiment, the present invention provides a label support which makes it possible to protect a label from external influences and to ensure its optical detection from the outside, so to speak.

In an embodiment, the present invention provides a transparent section which consists of a plastic which can be contactlessly detected or has a plastic which can be contactlessly detected.

An advantage achieved by the invention is that the plastic of the transparent section is designed to be detectable as such and, as it were, realizes a protective function as well as an optical detection of a region covered thereby, in which the label can be or is arranged.

The invention thus offers a further advantage in that the label can be arranged arbitrarily on the transparent section and can also be designed as a position mark or as a scale. The invention thus provides a wide range of applications for a label support according to the invention—in particular, in sensitive areas, such as those, for example, in the food industry and in cleanrooms—for example, in semiconductor production.

The contactless detection of a plastic proposed according to the invention for the transparent section can be performed, for example and in particular, by an inductive sensor.

By using a label support according to the invention, the detection of the plastic is thus independent of its optical detectability. Thus, the invention offers the advantage that, even in the event that the fragment has detached from the label support and enters the environment or a production material, reliable detection of these fragments or plastic particles is still possible, even if they are in the non-visible range or are concealed or covered by other parts/the production material.

In the context of the invention, “non-optical” means that detection is made possible independently of visual or optical detection by means of an optical sensor. It therefore allows detection when the relevant element or transparent section to be detected, as well as particles thereof, are concealed or covered.

Furthermore, it is provided according to the invention that the contactlessly detectable plastic be able to be detected in a passive state. Accordingly, no energy, such as current, is to be supplied to the plastic, in order to be able to detect it. Accordingly, the invention allows the transparent section formed by such a plastic in a label support according to the invention to be detectable in a passive state.

The invention thus realizes, independently of optical detectability, contamination by a label support according to the invention, which can also be caused by the transparent section thereof, so that corresponding measures can then be initiated in good time.

The invention also offers the advantage that, even when used in sensitive rooms or environments, the optical detection of the label or of a region located below the transparent section can take place safely, for example, and in particular by means of an optical sensor which optically detects the label or the aforementioned region.

The transparent section is configured and designed for optical detection of a label covered by the transparent section at least in portions or of a correspondingly covered region.

The invention thus makes it possible to optically detect a label from outside the label support by means of an optical sensor. Furthermore, it is thereby possible, during installation or maintenance work and during inspection processes, to visually perceive or detect an object provided with a label support according to the invention.

For this purpose, the invention advantageously allows a corresponding label support to be attached to a surface which can be optically detected through the label support and thus tested/controlled. This is advantageous, for example, in a region at risk of cracking or closing. In this respect, a label support according to the invention can also be used to apply wear or control markings to an object.

In the context of the invention, a label support according to the invention can be designed in different ways. For example, in the context of the invention, it is possible for the holding body to be formed from one or different plastic(s), whereby said plastic can advantageously be designed to be light and durable and optimized in regions for different requirements.

Advantageously, the holding body is formed from a plastic or different plastics, wherein the fragments with different regions or detached therefrom can be detected contactlessly and preferably non-optically—for example and in particular, in an inductive manner. Further advantages result if the holding body is formed from the same or a uniform plastic, such as the transparent section, thereby facilitating the recycling of a label support according to the invention.

Furthermore, according to the invention, a label support according to the invention can be configured and designed such that it is attached, e.g., in an embodiment as a type plate, to a device, such as, inter alia, a production apparatus or a tool. Furthermore, according to the invention, the label can be arranged at different points of the label support or of the holding body.

Accordingly, a label according to the invention can be arranged on an outer side of the holding body—for example, by being printed directly on a corresponding region of the holding body. This in turn can be done, for example and in particular, by means of ink-jet, thermal transfer, and laser printing. Furthermore, the invention makes it possible for the label to be attached to the holding body by means of a stamping method, and in particular a hot foil stamping method.

In this connection, the invention also makes it possible, inter alia, for the label to be arranged or arrangeable in a captive manner on the holding body.

According to the invention, a label support can be designed in various ways. It is thus possible to use different materials for realizing such a label support.

In a design as a transparent label support, the invention advantageously makes it possible, as already mentioned above, to optically detect a substrate or a surface on which a label support according to the invention is arranged or held, without having to remove the label support from the substrate.

Various other advantages are associated with this, e.g., in that the contents of a transparent container can be detected through the label support according to the invention, so that, for example, a fill-level of the container can be checked without having to remove the label support from the container.

According to the invention, the transparent section is formed from a plastic which can be contactlessly detected, and in particular in an inductive manner, or has such a plastic.

It is thus possible according to the invention for different types of sensor technologies to be used to detect the plastic independently of optical sensors. The invention thus makes it possible to use sensors which realize detection by means of X-rays or induction.

When inductive sensors are used, there is the advantage that they are cost-effective. The invention thus advantageously allows the plastic to be detected in a cost-effective manner for the transparent section.

The invention offers further advantages in that the relevant label support can be configured and designed, for example, for cable labeling, realizing type plates for different objects, for example and in particular, an adhesive label and a film body—in particular, a strip-like film body.

Finally, the invention offers the advantage that a relevant label support can be designed to be adapted for different purposes. For example, and in particular, for labeling operational or production means for the production, processing, handling, and checking or detection of products. The invention thus offers advantages which, for example, in the food sector and in the laboratory sector, make it possible to comply with purity or hygiene regulations.

According to the invention, a label arranged on the holding body can be realized in different ways. The label can be a marking, such as a position marking or a scale. Furthermore, the label can have characters, symbols, and colored areas so that the label can be used with a label support according to the invention in a manner adapted to the particular purpose. This results in many possible applications that allow not only color labeling, but also a variety of inscriptions and markings.

In addition, the invention has the advantage that the plastic which can be contactlessly detected can be used as an information carrier, in that information can be obtained from the plastic by detection, which information can result from the type as well as the composition of the contactlessly detectable plastic material.

The invention also allows the transparent section to be used as a light guide for transmitting light signals. Furthermore, in the context of the invention, it is possible to conduct currents by applying electrical energy and thus also to use the transparent section for conducting currents or signals as well as to excite it for illumination, as a result of which the label can also be optically recognized and detected in the dark.

According to the invention, the transparent section can, for example, form a view window via which the label is protected and, as it were, optically recognizable and detectable. For this purpose, it is possible for the transparent section to be realized as an integral component of the holding body and as an individual part, which can be connected or is connected to the holding body.

It is, inter alia, also possible in the context of the invention for the transparent section to be arranged on a side, facing the object to be labeled, of the holding body.

Irrespective of this, it is possible according to the invention to arrange the transparent section on a side, facing away from the object to be labeled, of the holding body.

The invention also considers the application case where a transparent section is formed both on a side, facing away from the object to be labeled, of the holding body and on a side, facing the object to be labeled, of the holding body.

The label itself can be attached on, integrally within, and below the transparent section. In addition, it is possible for the label to be attached to the holding body in a combination of the aforementioned arrangement options.

In order to protect the label, it is advantageously possible in the context of the invention to generate the transparent section, for example, by a coaching or coating of the holding body or a region of the holding body. For this purpose, the invention provides, for example and in particular, that the transparent section form a layer of the label support which can be formed and arranged on an outer side, but also in the interior, of the holding body.

Against this background, it is provided in an advantageous further development of the invention that the transparent section form a layer of the holding body at least in regions. The invention thus has the advantage that the transparent section can be made thin, so that a compact and lightweight design is obtained for a label support according to the invention.

A label support according to the invention can be designed in one part as well as in multiple parts. It is thus possible in the context of the invention, for example, to arrange the transparent section as an individual part on the holding body.

For this purpose, it is provided in a further advantageous further development of the invention that the holding body, in the installed state, have a lower part and an upper part arranged thereon, and the transparent section be arranged on the upper part and/or lower part.

In the context of the invention, an installed state is understood to be a state in which the lower part is arranged on the upper part. In the installed state, the label can already be arranged or will be arranged on the transparent section.

An arrangement according to the invention of the transparent section on an upper part has the advantage that the label arranged thereon can be clearly recognized and detected. The arrangement of the transparent section on the lower part has the advantage that optical detection can also take place by means of a sensor on a side other than that of the upper part. This has the advantage that, for example, in the case of a transparent object to which a label is to be applied, the label can also be arranged close to the object in question, so that the label can also be detected from one direction from the object. This is advantageous, for example, in transparent vessels or containers in order to be able to better detect their contents optically.

It is thus possible according to the invention to, for example, label a transparent container in such a way that the label can be detected from the interior of the container. This can be advantageous, for example, in the case of a graduated cylinder.

Furthermore, the invention makes it possible for the substrate or a surface of the object to be labeled, on which the label support is arranged in a holding state, to remain recognizable. This can be advantageous, for example, for substrate inspection, as is necessary, for example, to determine wear or damage. This eliminates the need to remove the label support from the underlying substrate, resulting in handling and time advantages.

In order that the label be protected by the transparent section on one side and the substrate on which the label support according to the invention is arranged remain optically recognizable or detectable, the invention also comprises the possibility that both the upper part and the lower part of the holding body are designed to be transparent.

Accordingly, the invention makes it possible for the transparent section to extend on or over the upper part and the lower part of the holding body. By using the same plastic that can be contactlessly detected to form the upper and lower parts, production and recycling advantages are achieved.

In the context of the invention, it is thus possible for the transparent section to extend completely or partially over the upper part or the lower part or both parts.

The invention also comprises the possibility that the label be designed in the manner of a label that can be arranged between the upper part and the lower part of the holding body. Furthermore, the sides or surfaces provided for attaching the label can be configured and designed for direct printing with the label.

Accordingly, a further advantageous further development of the invention provides that the upper part and/or the lower part or the transparent section be configured and designed for attaching a label, and in particular a print with a label.

For printing on a surface, the invention considers a correspondingly designed region whose surface is configured and designed for printing. Furthermore, it is possible according to the invention to attach and secure the label by means of an adhesive means, such as a glue, to a region provided for this purpose on the holding body.

In order to protect the label, for example and in particular, from abrasion, damage, and environmental influences, the invention provides that the transparent section cover the label at least in sections.

Particularly good protection is achieved by the transparent section completely covering the label, so that optical detection by means of a sensor is ensured, in addition to corresponding protection.

Against this background, a further advantageous further development of the invention provides that the holding body be configured and designed such that the label, and in particular a label element, in the installed state, can be arranged or is arranged between the upper part and the lower part.

Various plastics can be used to produce a label support according to the invention. A further advantageous further development of the invention is therefore aimed at the plastic material which can be contactlessly detected being an electrically-conductive plastic or having such a plastic. The use of an electrically-conductive plastic has the advantage that a label support formed according to the invention can also be used for conducting electrical energy and electrical signals. In this context, the use of an electrically-conductive plastic results in many possible applications, so that a label support according to the invention can be used multifunctionally.

The invention thus realizes the advantage that a label support according to the invention is not only configured and designed for the arrangement of a static label, as described above, but also offers the advantage that at least the transparent section can be used for electrical and light conduction. In addition, the transparent section can be excited for illumination by supplying electrical energy, as already mentioned above.

The invention has shown that intrinsically-conductive plastics offer a very good, extended possibility of realizing a plastic which can be contactlessly detected. According to the invention, therefore, in particular, electrically-conductive polymers can be used to realize a transparent and contactlessly detectable section.

In a further advantageous further development of the invention, it is provided that the electrically-conductive plastic consist of an intrinsically-conductive polymer or have an intrinsically-conductive polymer.

The electrical conductivity of such polymers is initially sufficient for the aforementioned detection of these polymers. Suitable conductive polymers in the context of the invention include, but are not limited to, doped polyacetylene, polypyrrole, polyphenylene sulfide, and polythiophene, as well as organometallic complexes having macrocyclic ligands such as phthalocyanine.

In the context of the invention, it has also been shown that detectability is related to the electrical conductivity of the plastic, so that an increase can be achieved with increasing conductivity.

It has thus proven to be extremely advantageous within the invention to use intrinsic conductive polymers in order to achieve excellent contactless, non-optical detectability in addition to an excellent transparency for the transparent section.

It is thus advantageous according to the invention to use polymers for a label support which are not electrically conductive by nature. The invention has made it possible to exploit the advantageous properties of these polymers for a label support according to the invention. The invention thus opens up the use of different types of polymers, so that a polymer predestined for the particular use can be used. Cost benefits thus also result.

Surprisingly, it has been found here that not only is the electrical conductivity comparable to that of metals, but contactless detectability is also possible in a case where the transparent section, or a fragment detached therefrom, is completely concealed and no longer optically detectable.

In addition to the transparent section, the holding body or its upper part and lower part can, as already described above, be formed from or have, at least in sections, an electrically-conductive plastic or an intrinsically-conductive polymer.

In this connection, it has also been advantageously found in the context of the invention that such plastics can also be dyed, so that a coloring of the plastic can be realized as desired. The plastic can thus also serve as a color marking, for example.

In the context of the invention, it was found that, in addition to intrinsically-conductive polymers, it is also possible to make polymers conductive by admixing metal particles and carbon black. However, carbon black can affect transparency, such that, in the context of the invention, the admixture and its distribution of additives to form an electrically-conductive plastic is such that the transparency ensures optical detectability of a label by means of an optical sensor.

In the context of the invention, a further or complementary option has been found to be very suitable, which consists of the electrically-conductive plastic having an electrically-conductive additive, as is taken into account in a further advantageous further development of the invention.

In order to achieve a high transparency for the transparent section and also for further regions of a label support according to the invention, it is provided in a further advantageous further development of the invention that the conductive additive be formed from at least one of the following components: indium tin oxide, fluorine tin oxide, aluminum zinc oxide, antimony tin oxide.

In the context of the invention, the aforementioned additives have proven to be very suitable and, in addition to good detectability, provide sufficiently good optical detectability of a label located on the transparent section of the holder body.

In this connection, it was likewise found that these additives can be added to the polymer in question at a very low dosage, so that the presence thereof affects the transparency of the transparent section at most only to a very small extent, which can be tolerated for optical detection.

In order to promote detectability, it is provided in a further advantageous further development of the invention that the conductive additive be distributed uniformly, and in particular homogeneously, in the transparent section. This also advantageously promotes the detection of fragments of the transparent section that may become detached due to external influences and thus could enter a sensitive material, such as food.

The same applies to other sensitive regions—for example, a cleanroom and a laboratory. The invention thus ensures that a possible contamination of a material or production material can be determined immediately by reliably detecting the undesired components even if they are concealed by the material or production material, and thus corresponding removal of the foreign body or the contaminated material or production material can be carried out immediately and safely.

The invention led to the finding that a label support formed according to the invention can be realized very well by certain polymers.

A further advantageous further development of the invention is based upon the fact that the electrically-conductive plastic has at least one of the following polymers or is formed by means of at least one of the following polymers: polyacetylene, polyaniline, polyparaphenylene, polypyrrole, polythiophene, poly-3,4-ethylenedioxythiophene (PEDOT), or PEDOT:PSS.

According to the invention, a series of ideal polymers are thus available which are ideal for a label support according to the invention, in order to realize the respective functions (in particular, electrical conductivity, transparency).

In the context of the invention, the plastics already mentioned can be used in different regions of a label support according to the invention, so that, in a further advantageous further development of the invention, it is provided that the holding body have the same plastic as that of the transparent section or be formed from such a plastic.

For this purpose, a further advantageous further development of the invention determines that the holding body is formed—in particular, uniformly—from an electrically-conductive plastic. This has the advantage that contactless, non-optical detectability is realized for all components of a label support or holding body according to the invention. The holding body preferably consists of the same electrically-conductive plastic.

Attaching a label support according to the invention to an object to be labeled can be done in various ways. In a further advantageous further development of the invention, the holding body is configured and designed to be particularly advantageous for simple handling, such that it is held in a holding state by means of holding means—in particular, releasably, and preferably without tools—on the object to be labeled.

It is thereby achieved that only a small handling effort is required to hold the label support according to the invention on an object to be labeled. In particular, a tool-free releasability means that a label support according to the invention can also be removed from a body in a simple manner. The holding means may, for example and in particular, be provided with locking means to allow holding on a body.

In the context of the invention, the holding means can be configured designed in different ways. For example, it is possible to design the holding means in such a way that they are integrally connected to the holding body.

To further simplify handling for attachment thereof to an object to be labeled of a label support according to the invention, it is provided in a further advantageous further development of the invention that an adhesive means be arranged as a holding means at least on a side, facing, in the holding state, the object to be labeled, of the holding body, by means of which adhesive means the holding body adheres to the object to be labeled, and in particular is held thereon in a material-bonded manner.

According to the invention, various adhesive means can be used to attach the holding body to an object. In the context of the invention, an adhesive means can thus be configured and designed or formed, for example, as or by means of a hook-and-loop connecting means, adhesive(s), or adhesive strip(s).

By using an adhesive means for a releasable connection between the label support according to the invention and the object to be labeled, the invention provides that, in addition to a simple attachment of a label support according to the invention, a simple removal of an object also be possible.

Furthermore, the invention makes it possible to use an adhesive means that realizes a strong, and in particular non-destructively releasable, connection between a label support according to the invention and the object to be labeled.

According to the invention, an adhesive means can also be an adhesive strip or an adhesive layer, for example, which is attached to a corresponding side of the holding body with which the label support according to the invention is or will be arranged on the object to be labeled.

According to the invention, it is possible to attach the label to the label support at different locations. As already explained, the label itself can be formed in different ways.

For good detectability, however, it is crucial in the majority of applications to be able to optically detect the label from the outside. The invention makes this possible by arranging the label at least partially on the transparent section.

In order to be able to protect the label from external influences, it is advantageous for the label to be covered at least partially by the transparent section. According to the invention, this is achieved, in particular, when the label can be or is arranged on a side of the transparent section which, in the holding state of the holding body or label support according to the invention, faces the object to be labeled.

For this purpose, it is provided in a further advantageous further development of the invention that the label be printed at least partially on the transparent section, and in particular on a side, facing, in the holding state, the object to be labeled, of the upper part and/or of the lower part.

Compared to a hot foil stamped label, printing the label on a label support according to the invention has the advantage that printing can take place quickly and cost-effectively. Furthermore, the advantage results that different colors can be used for printing or embossing. In addition, any characters and color regions and the like can be created in a correspondingly simple and quick manner. The invention thereby makes it possible to attach a label in a very flexible manner.

According to the invention, labeling can also be performed after the label support has been attached to the object to be labeled. The invention thus also allows for the subsequent creation of a label and attachment to a holding body according to the invention.

If the imprint of the label is covered by the transparent section, the advantage is that the printing is also protected from manipulation. In order to create a corresponding imprint, various printing methods can be used in the context of the invention—for example and in particular, methods such as ink-jet, thermal transfer, or laser printing.

Furthermore, the invention makes it possible to obtain the label by means of laser irradiation of the transparent section, so that the label is introduced into the interior of the transparent section by laser irradiation.

Thus, an advantage is that the label is attached to a label support according to the invention in a very tamper-proof manner. In this respect, manipulation can in particular be achieved only by destroying the transparent section.

Thus, a laser label makes it possible for a label to be attachable or attached to a label support according to the invention in a tamper-proof, abrasion-resistant, and permanent manner.

Against this background, it is provided in a further advantageous further development of the invention that the label be formed at least partially as a laser label in the interior of the transposed section.

According to the invention, permanent labeling of objects such as components or devices is achieved by a laser label. According to the invention, different beam sources can be used to introduce a laser label into the transparent section, whereby different materials can advantageously also be provided with a label. It is thus also possible to introduce hidden labels in the interior of an opaque region of a label support according to the invention.

In this respect, a hidden copy protection is realized in a simple manner by means of a label support according to the invention. For this purpose, it is advantageous that said label support is firmly, and in particular integrally, connected to the object to be labeled and thus, in particular, cannot be removed from the object in question without destruction.

Furthermore, the laser label in the context of the invention also allows for the realization of three-dimensional labels, whereby complex labels are, advantageously, also made possible.

In order to realize an abrasion-resistant label application which is as permanent as possible, a further advantageous further development of the invention provides that the upper part, in the installed state, cover the label at least in sections, and in particular completely.

It is thus also possible to protect the label from external environmental influences or aggressive media.

In order to realize the largest possible region for the label, an advantageous further development of the invention provides that the transparent section extend along the upper part. The surface size of the transparent section is thus substantially or congruent with the corresponding surface of the upper part. This results in a large region for attaching and protecting a label.

In order to promote simple handling, in the context of the invention, an advantageous further development provides that the holding body be configured and designed such that the upper part and the lower part can be separated from one another—in particular, in a non-destructive manner, and preferably without tools.

The invention thereby advantageously achieves that a good removal possibility is realized when the label is attached to the holding body. For example and in particular, the label is arranged between the upper part and the lower part so as to be removable, so that said label can be easily removed from a label support according to the invention. The label can thus advantageously be arranged subsequently on the label support according to the invention. It is also advantageous that the label can be replaced.

Furthermore, it is possible to easily replace the upper part or lower part. In addition, it is possible to attach or print the label on the upper part or lower part before attaching said label to the body to be labeled. In this way, the advantage is achieved that the label can already be attached to a label support according to the invention or to its holding body or its upper/lower part, independently of its installation on a body to be labeled. This facilitates automatability for the attachment of the label to a label support according to the invention.

In order for the upper part to be securely held on the lower part, it is provided in a further advantageous further development of the invention that the upper part and the lower part be integrally connected to one another in an installed state.

A label support according to the invention can be designed, for example and in particular, in the form of a film body which can be designed to be transparent and also multilayered. For easy attachment to an object to be labeled, an adhesive means can be arranged on at least one side of the film body, as already explained above. In addition, in the context of the invention, it is possible to arrange the label between one of the layers in order to realize a manipulation security of the label, as already shown.

In order to promote a compact design, simple logistics, and handling, a further advantageous further development of the invention provides that the upper part and the lower part be connected to one another in one piece in a connecting section (58). This also advantageously prevents the upper and lower parts from being easily detached from one another, and, accordingly, the risk of unwanted contamination is also reduced by a label support according to the invention.

In order to improve the handling for the attachment of a label to a label support according to the invention, it is provided in a further advantageous further development of the invention that at least one, and in particular straight, folding line be formed on the connecting section, along which folding line the upper part and the lower part can be folded relative to one another in such a way that the upper part and covers the lower part at least in sections, and preferably substantially or congruently, in a folded state.

In the context of the invention, a folding state of the label support means a state in which the upper and lower parts are folded relative to one another on the folding line and cover one another at least in portions.

The use of a label support according to the invention is possible within broad limits. An intended use according to the invention is the use of such a label support on a cable, a hose, a tube, a rod, and similar objects, which in particular extend longitudinally along an axis and, for example, have a substantially uniform cross-section. In this respect, according to the invention, it is also provided that the holding body be configured and designed for the circumferential wrapping of a cylindrical object to be labeled. The circumference of the body to be labeled is thus related to a body axis of the object to be labeled, along which said object extends longitudinally.

In the context of the invention, a cylinder-like, and in particular cylindrical, object also comprises a tubular or hollow body, such as an, in particular, flexible, tube and a sheath.

For this purpose, it is provided in a further advantageous further development of the invention that the holding body be configured and designed for the circumferential wrapping of a cylindrical object to be labeled, and in particular a cable, a hose, a tube, a rod.

The invention also comprises a use for a packaging means, and in particular a food or hygiene packaging means, wherein the advantages of a label support according to the invention come to bear. According to the invention, the at least for temporary packaging of such a material can be configured and designed, such as a food or a sterile or disinfected means.

According to the invention, a packaging means can, for example and in particular, be a film packaging, a cardboard box, a tray, and a container and the like. Accordingly, it is possible to use the aforementioned advantages of a label support according to the invention during storage in a sensitive area.

According to the invention, it is possible for the label support to be configured and designed such that it can be wrapped around an object, and in particular in such a way that the section of the holding body formed at one free end overlaps a section of the holding body formed at another free end.

For this purpose, it is provided in a further advantageous further development of the invention that the extension of the upper part and of the lower part in a direction of arrangement in which they are arranged side by side be dimensioned such that, in the holding state in which, in the context of the invention, the holding body is arranged on the, in particular, cylinder-like or cylindrical, object to be labeled, a free end of the holding body overlaps another free end at least in sections in an overlapping section. The relevant sections of the corresponding free ends of the holding body thus overlap in the holding state in which the label support is arranged on the object to be labeled.

Against this background, a label support according to the invention can be arranged on different objects, so that the invention also comprises a use of an aforementioned label support on an, in particular, cylinder-like or cylindrical object.

As already mentioned above, such an object can, for example and in particular, be a measuring cup, a graduated cylinder or a test tube, or an, in particular, cylinder-like or cylindrical, container.

In addition, a further advantageous further development of the invention relates to a production means having an, in particular, cylinder-like or cylindrical, body and having a label support attached thereto, which is formed according to at least one of the preceding embodiments.

A label support according to the invention is preferably configured and designed as an industrial label support which serves to label production means and the use of which is comprises such a label according to the invention.

In the context of the invention, the invention also comprises as a production means a use of a label support according to the invention for a production apparatus, and in particular for a food production apparatus. According to the invention, such a production apparatus also comprises individual parts, assemblies, and other components of a production apparatus, which are also covered by the term, production apparatus.

The idea of the invention is also clearly embodied in a production system which also comprises detection of a label support according to the invention.

Accordingly, in a further advantageous further development of the invention, a production system having a detection unit is provided which is configured and designed to detect the label support and also fragments of the label support by means of sensor means.

This has the advantages that a fragment of the label support according to the invention, which may be detached from a production means, can be detected at an early stage by means of the detection unit, and thus the relevant material/product material, which the fragment or the label support inadvertently enters, can be detected at an early stage, and handled or rejected accordingly.

For this purpose, for example and in particular, an inductive sensor can be used as a sensor means that detects the aforementioned fragment or the label support. These detection data can be provided to a control or monitoring apparatus for further processing and, in particular, for taking further measures, which is/are connected to the detection unit in terms of signaling.

This also includes the use of a label support according to the invention in so-called cleanrooms, which can, for example, be production rooms for semiconductors, food, medicine, and pharmaceuticals.

Accordingly, the invention also comprises, as a production means, laboratory equipment which has a label support according to the invention. Such laboratory equipment includes, for example, in particular microscopes, storage means, centrifuges, test tubes, and other known laboratory equipment.

The invention is explained in more detail below with reference to the attached drawing, in which a selection of exemplary embodiments of label supports according to the invention and their possible uses are shown as representative of a plurality of implementation options.

The features are therefore not bound to the configurations explained below and shown in the figures, but can also form label supports or apparatuses according to the invention when isolated from each other as well as in a varying combination.

The figures in the drawing show the aforementioned exemplary embodiments according to the invention in a schematic representation. The illustrations in the figures are therefore in particular not necessarily to scale, so that the scales selected in each case in the figures may also differ from each other.

For better clarity, the representations are reduced to the elements/parts/components that support understanding.

In the figures, identical or corresponding parts/components or elements are provided with the same reference signs.

For a better overview, not all elements/components/component parts are always provided with reference signs in the figures, wherein the assignment results from the same illustration or an illustration adapted to the respective view.

In the case of the same or a similar structure, the description is reduced below to the differences between the exemplary embodiments or representations in the figures for a better overview.

The features illustrated on the basis of in the figures also apply correspondingly or analogously, comprehensively as well as in a manner isolated from each other, to different exemplary embodiments and other label supports according to the invention and use thereof. The invention is not limited to the exemplary embodiments or associations that are described and shown.

Furthermore, a label support according to the invention is also referred to as a label support for short in the following.

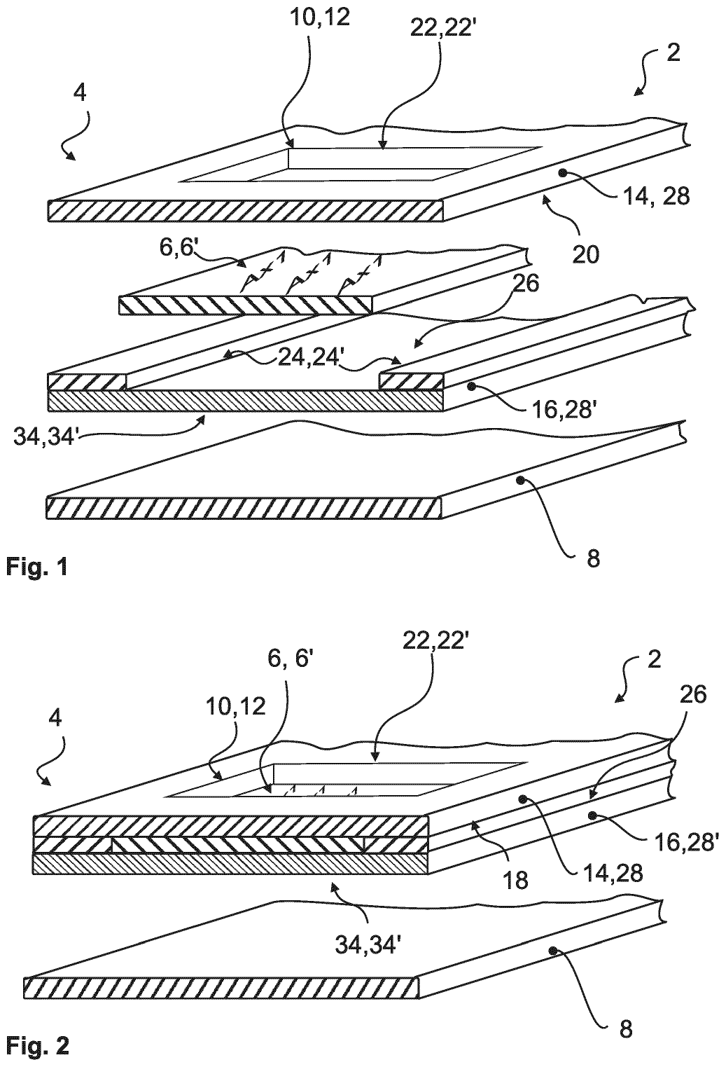

FIG. 1 and FIG. 2 show a first exemplary embodiment of a label support 2 according to the invention, having a holding body 4 for holding a label 6, which is arranged thereon, on an object 8 to be labeled, wherein the holding body 2 has a transparent section 10 for arranging a label 6.

The transparent section 10 consists of a plastic 12 which can be detected contactlessly and inductively. In addition, the transparent section 10 in this exemplary embodiment is an integral part of the upper part 14 of the holding body 4.

Furthermore, the holding body 4 has a lower part 16 which, in the installed state, is arranged on the upper part 14.

In this exemplary embodiment, the label 6, in the installed state, is arranged between the upper part 14 and the lower part 16. The label 6 consists of a print 6′, which is directly attached to a side 20, facing the lower part 16, of the transparent section 10. For this purpose, the transparent section 10 is configured and designed for printing.

The label 6 is such that it can be or is visually detected by an optical sensor, such as a camera, from outside the label support 2.

In this exemplary embodiment, the plastic 12 which can be contactlessly detected is an intrinsically-conductive polymer, wherein the upper part 14 (except for the transparent section 10) and the lower part 16 are opaque and consist of a different plastic—in each case, a polymer.

As shown in FIG. 1, the transparent section 10 forms a region 22 of the upper part 16 in this exemplary embodiment, as a result of which a view window 22′ is formed.

In the installed state, the upper part 14 is connected to the lower part 16 by an adhesive means 24 arranged therebetween, wherein they are integrally connected to one another in this exemplary embodiment.

In this exemplary embodiment, the adhesive means 24 are attached to the side 26, facing, in the installed state, the upper part 14, of the lower part 16, which adhesive means is formed by two adhesive strips 24′.

Alternatively, the adhesive means 24 can also be arranged on a side 20, facing, in the installed state, the lower part 16, of the upper part 14 and can also be designed, for example, as an adhesive layer.

In another alternative, the adhesive can also be arranged, for example, on both of the aforementioned sides 20, 26. Furthermore, the adhesive means 24 can be applied to the corresponding side 20, 26 in regions, as well as over the entire surface.

In the context of the invention, an adhesive means 24 can be realized in a variety of ways, such that the possibilities mentioned in the exemplary embodiments are examples to which a realization according to the invention is not limited.

As can be seen from FIG. 1, the upper part 14 with the transparent section 10 arranged thereon completely covers, in the installed state, the label 6 attached thereto.

In the first exemplary embodiment, the upper part 14 and the lower part 16 are formed by plate-like elements 28, 28′ which are designed so as to be substantially congruent with one another and between which the label 6 is arranged.

FIG. 2 shows the parts in an installed state, with the parts (4 through 28, 28′) of the label support 2 previously described in FIG. 1 arranged on top of one another and thus prepared for attachment to an object 8 to be labeled. The transparent section 10 thereby protects the label 6, 6′ from external environmental influences and also ensures optical detection of the label 6, 6′ from the outside—for example, by an optical sensor.

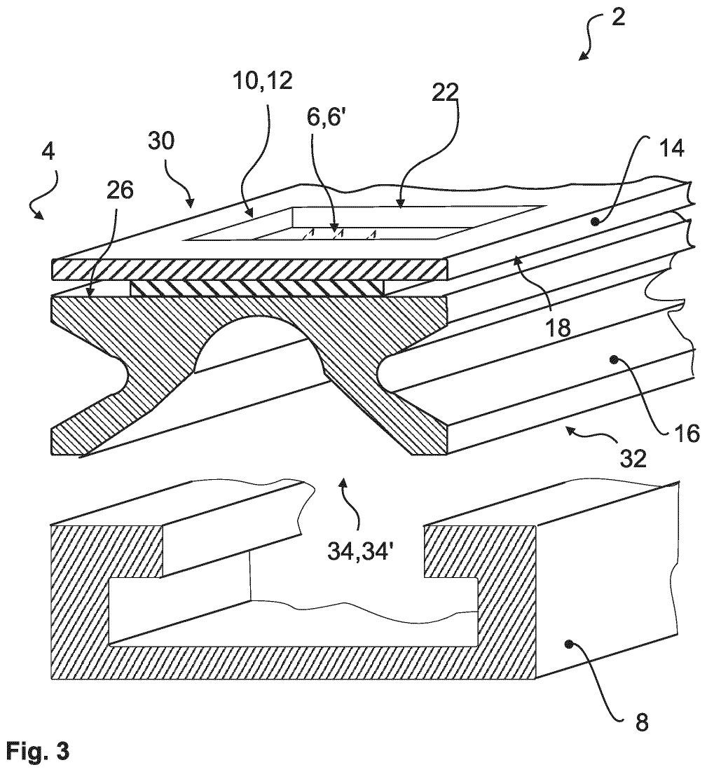

FIG. 3 shows a second exemplary embodiment of a label support 2 according to the invention in which the upper part 14 is formed from a film or a film body 30, and the lower part 16 is formed from an extruded body 32. The lower part 16 is designed in such a way that it is held with its underside 34 in a form-fitting manner on the object 8 to be labeled in a holding state by being arranged or held on the object 8 to be labeled according to the invention. The underside 34 of the lower part 16 is thus a side 34′, facing, in the installed state, the object to be labeled, of the holding body 4.

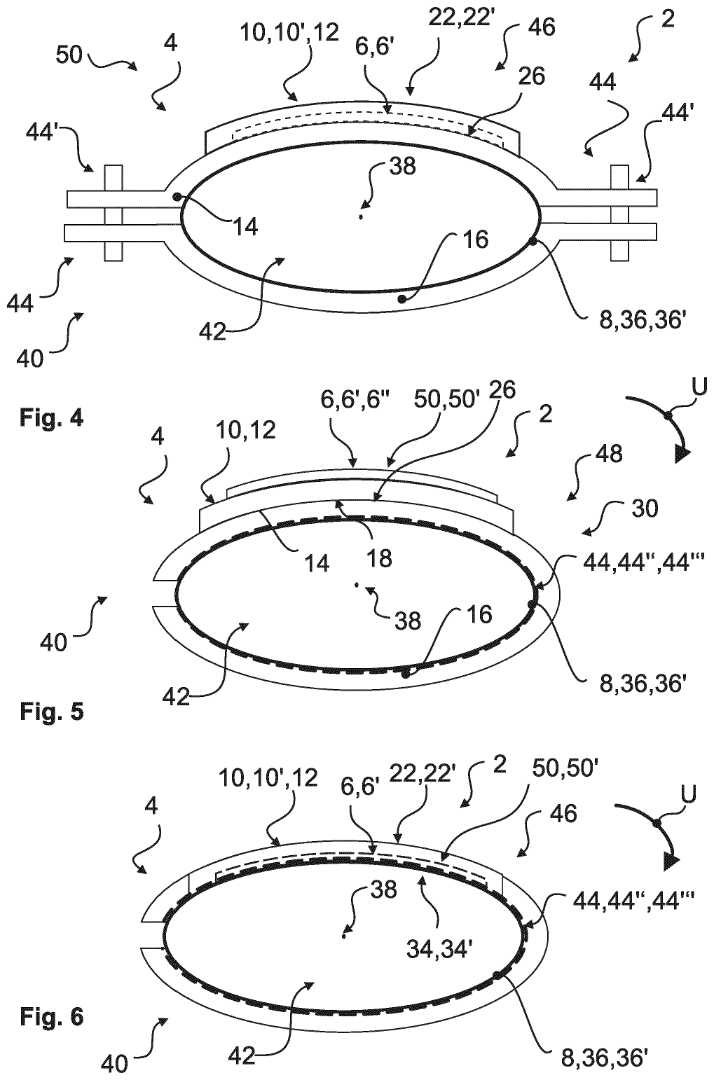

FIG. 4 shows a third exemplary embodiment of a label support 2 according to the invention in a holding state. In the holding state shown in FIG. 4, the holding body 4 is arranged on an object 8 to be labeled, wherein the cylindrical object 36 to be labeled is arranged between the upper part 14 and the lower part 16.

In this case, the object 36 to be labeled is cylindrical and has an oval cross-section. It extends longitudinally along an axis 38 (body axis). Due to the selected cross-sectional representation, the longitudinal extension of the object 36 is directed into the drawing plane so that a free end 40 of the object 36 with the label support 2 arranged thereon is shown. Furthermore, the interior 42 of the object 36 is hollow and forms a tube 36′ for conducting fluids or bulk materials. In the context of the invention, fluids can be gaseous and liquid substances. In the context of the invention, bulk materials include pourable substances, such as, in particular, powders, granules, grains, cereals, gravel, sand, and the like.

The holding body 4 in turn consists of an upper part 14 and a lower part 16, which are formed from a polymer in a shell shape and are held against one another by means of holding means 44. In this case, the holding means 44 are designed as a screw connection. In the context of the invention, the holding means can also comprise or be formed by snap-on or locking means, rivets, adhesives, and the like, independently of the exemplary embodiments described herein. Furthermore, it is possible to form the holding means by means of a film hinge. In this exemplary embodiment, the upper part 14 is thus held against the lower part 16 by means of two screws 44′, as a result of which they are held, in the holding state shown, in a clamping manner on the object 36.

The transparent section 10 is arranged on a side 48, facing away from the object 36, of the holding body 4 or upper part 14 and is formed by a coating 10′ which covers the label 6 attached to the upper part 14 and forms a seal of the label 6 which protects said label from external influences and manipulations. In this case, the coating 10′ covers the upper part 14 in a region 46 in which the label 6 is arranged.

In this exemplary embodiment, the label 6 is printed directly on the upper part 14 by means of ink-jet printing. In this case, the label 6 is arranged on a side 48, facing, in the holding state, away from the object 36, of the upper part 14 or of the holding body 4.

The upper part 14 and the lower part 16 each consist of an opaque plastic, wherein these (both or only one of the two), according to the invention, also consist of the same plastic as the transparent section 10 and can likewise be transparent.

FIG. 5 illustrates a fourth exemplary embodiment of a label support 2 according to the invention in a holding state. The holding body 4 is formed from a foil as a foil body 30, wherein said holding body is arranged on the object 36 to be labeled by means of a holding means 44. The holding means 44 is formed by an adhesive means 44″. The adhesive means 44″, in turn, is an adhesive layer 44″ (symbolized by a dashed circumferential line) which is arranged between the cylindrical object 36 to be labeled and the holding body 4 and connects them to one another.

The transparent section 10, on which the label 6 is arranged by a label element 50 in the form of a printed adhesive label 50′, is arranged on a side 48, facing, in the holding state shown, away from the cylindrical object 36 to be labeled, of the holding body 4.

In this exemplary embodiment, the holding body 4 is configured and designed to circumferentially wrap a cylindrical object 36 to be labeled, such as a cable, a hose, a rod, and the like. In this exemplary embodiment, the object 36 to be labeled is a tube 36′.

As shown in FIG. 5, according to the invention, the circumferential wrapping is directed in the circumferential direction U towards the body axis 38, along which the object 8 to be labeled, or, in this exemplary embodiment, the cylindrical object 36 to be labeled, extends longitudinally. According to the invention, however, the circumferential wrapping need not extend over the entire circumference, but can also comprise a circumferential section and, accordingly, also extend over a partial circumference.

FIG. 6 shows a fifth exemplary embodiment of a label support 2 according to the invention in a holding state, wherein, in contrast to the fourth exemplary embodiment, said label support has a label 6 which is arranged on the side 34′ facing, in the holding state shown, the object 36 to be labeled. The transparent section 10 is formed integrally in a region 46 of the holding body 4 and, in turn, provides protection and a view window 22 for the label 6 by covering the label 6. The label 6 is in turn a label element 50 in the form of a printed adhesive label 50′.

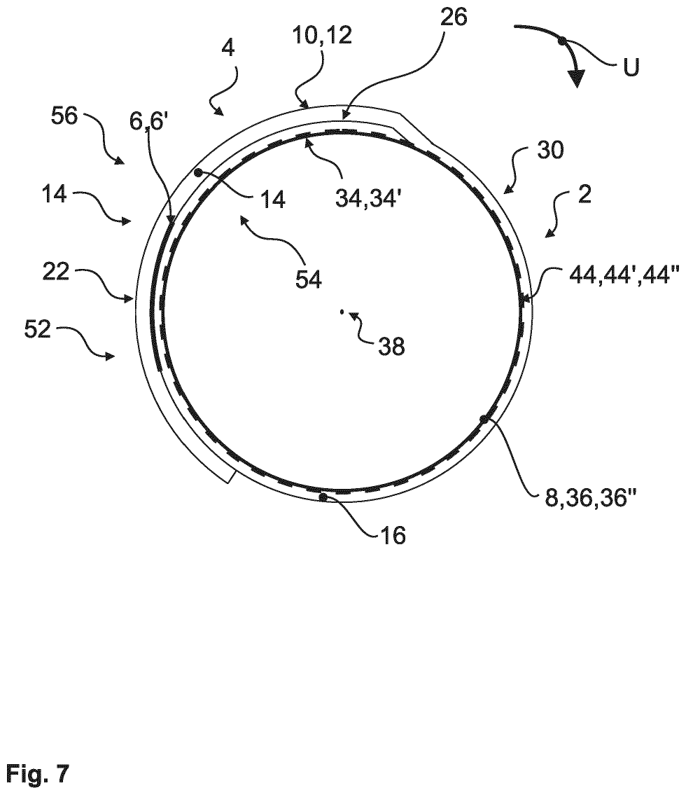

FIG. 7 shows a holding state of a sixth exemplary embodiment of a label support 2 according to the invention, in which the transparent section 10 extends along the upper part 14 of the holding body 4.

The holding body 4 is formed by a multilayer film body 30 and is configured and designed such that the upper part 14 and the lower part 16 are integrally connected to one another. In this case, the holding body 4 is configured and designed to circumferentially wrap a cylindrical object 36 to be labeled—for example and in particular, a hose, a tube, a rod, and the like.

In the holding state shown in FIG. 7, the cylindrical object 36 to be labeled is a cable 36″ which is used to conduct electricity/data in a switching cabinet.

As shown again in FIG. 7, according to the invention, the circumferential wrapping is directed in the circumferential direction U towards the body axis 38, along which the object 8 to be labeled—in this case, the cylindrical object 36 to be labeled—extends longitudinally. This exemplary embodiment shows that the holding body 4 is configured and designed to completely circumferentially wrap the object 8 to be labeled.

The upper part 14 is formed at one free end 52 of the holding body 4 and the lower part 16 at another free end 54 of said holding body, wherein the free ends 52, 54 are opposite ends 52, 54 of the holding body 14.

In this case, the one free end 52 of the holding body 4 overlaps the other free end 54 of the holding body 4 in an overlapping section 56.

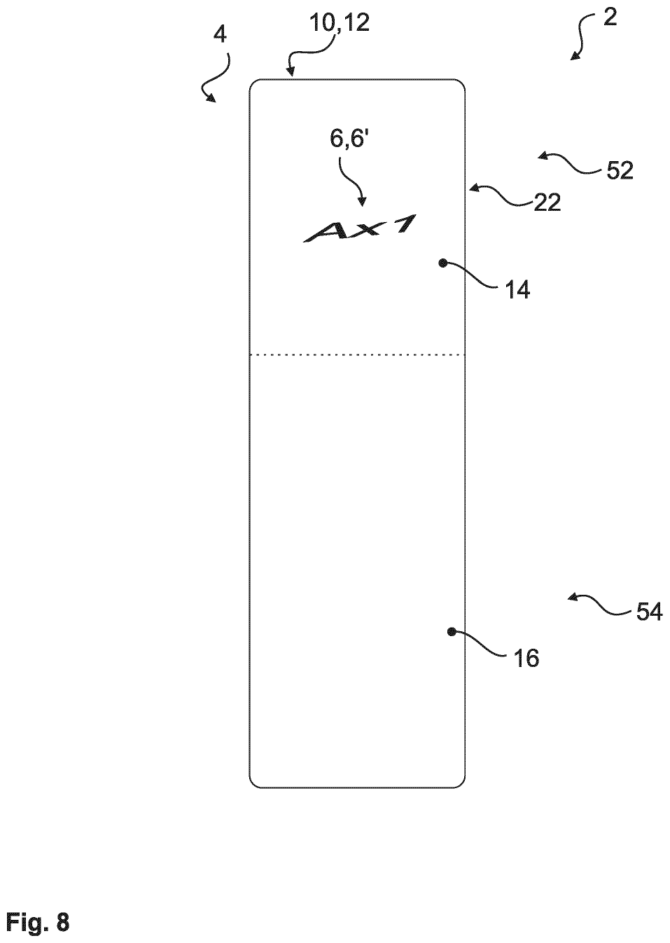

FIG. 8 again shows the sixth exemplary embodiment of a label support 2 according to the invention from FIG. 7 in a longitudinal extension. In this case, the extension of the upper part 14 and the lower part 16 in the direction of arrangement shown, in which they are arranged side by side, as shown in FIG. 8, is dimensioned such that, in the holding state shown in FIG. 7, in which the holding body 4 is arranged on the object 6 to be labeled, a free end 52 of the holding body 4 overlaps another free end 54 of the holding body 4 at least in sections in an overlapping section 56 (shown in FIG. 7).

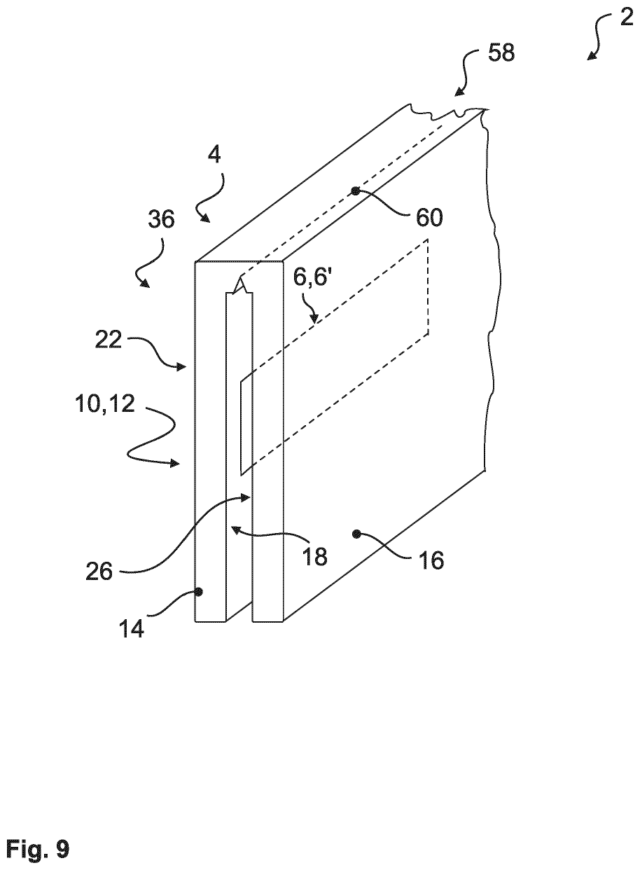

FIG. 9 shows a seventh exemplary embodiment of a label support 2 according to the invention, the holding body 4 of which in turn is formed from a strip-like film body 36. The holding body 4 is divided into an upper part 14 and a lower part 16. In this exemplary embodiment, the upper part 14 and the lower part 16 are integrally connected to one another in a connecting section 58.

A straight folding line 60 is formed on the connecting section 58, along which folding line the upper part 14 and the lower part 16 can be folded relative to one another in such a way that the upper part 14 and covers the lower part 16 in the folded state shown in FIG. 9 in sections and, in this exemplary embodiment, substantially congruently.

In this exemplary embodiment, the folding line is formed by a groove 61 which has a notch-like design and runs transversely to the longitudinal extension of the holding body 4.

According to the invention, in the case of similar or differently designed exemplary embodiments of the invention, the folding line 60 can also be formed, in addition to a groove, by, inter alia, a slit, a (linear) perforation, an embossing, and the like.

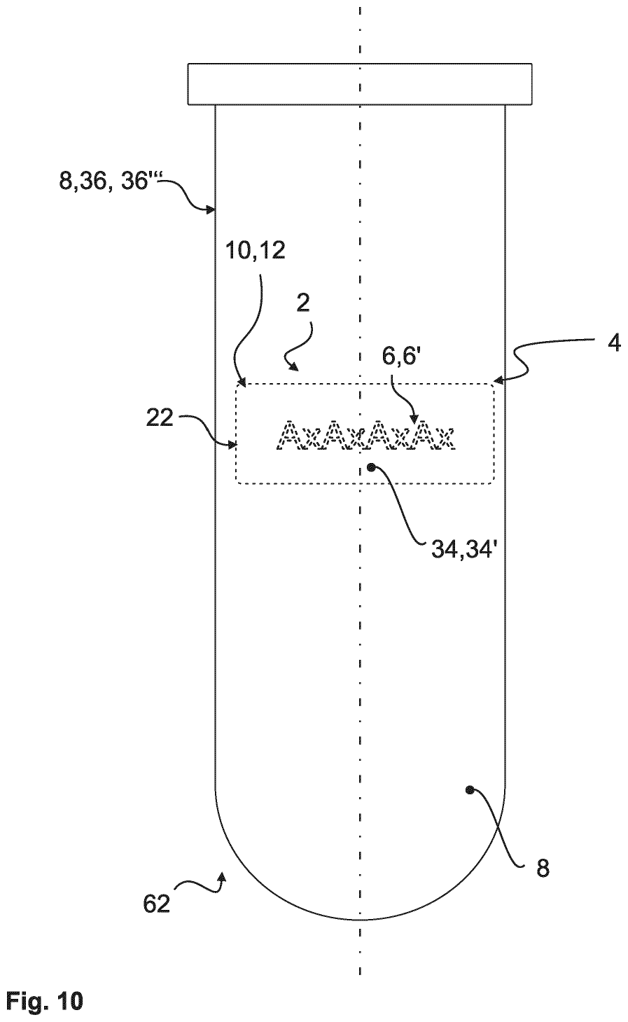

FIG. 10 shows, in an eighth exemplary embodiment of a label support 2 according to the invention, a holding state in which it is arranged on a transparent container 36″, which in this exemplary embodiment is the object 8 to be labeled.

The label 6, 6′ is here arranged on a side 34′ facing the object 8, as a result of which both the fill-level of the container 36″ and, at the same time, its surroundings can be better detected, which is advantageous, for example, in the production sector and in the laboratory sector. For the purposes of the invention, the container 36″ is thus also a production means 62.

In the context of the invention, a container does not necessarily have to be cylindrical, but can also have a different shape.

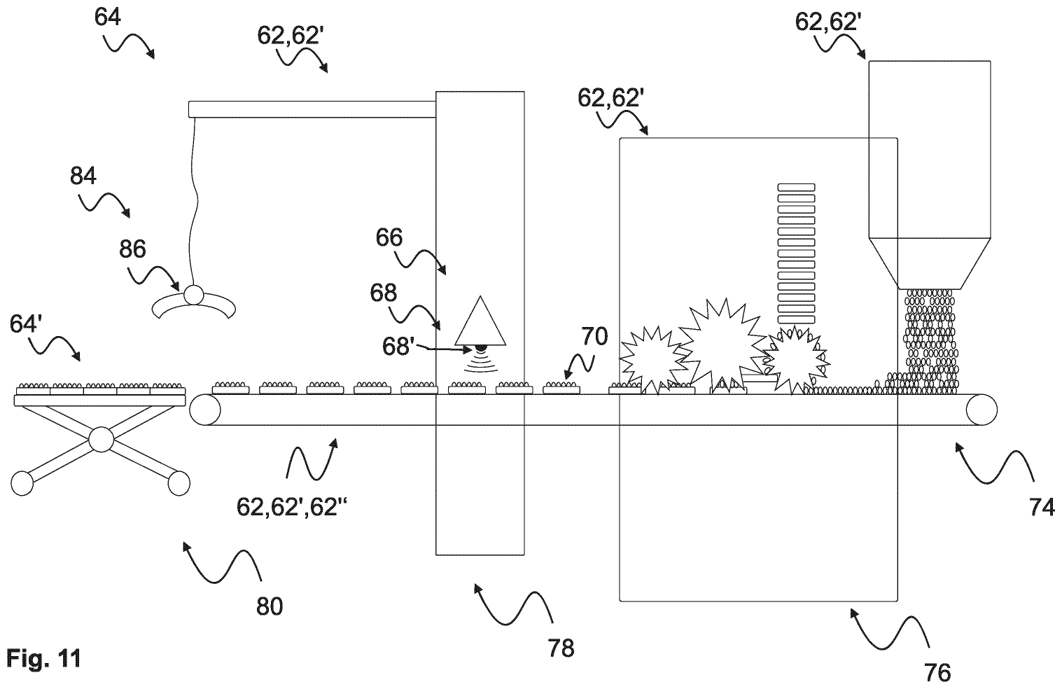

FIG. 11 shows a production system 64 which, according to the invention, has a label support 2 which is designed according to the invention as described above. The label support 2 (not shown in FIG. 11 for better clarity) can be arranged, with a label 6 arranged thereon, on a production means 62, such as a production machine 62′ or a part thereof (not shown in FIG. 11 for better clarity).

Furthermore, according to the invention, it is possible to provide all parts to be labeled of a production system 62 with a label support 2 according to the invention, thereby promoting, inter alia, the detection of the operating equipment and the prevention of contamination.

In addition to a production machine 62′, the production system 64 shown in FIG. 11 also has a detection unit 66 having sensor means 68. The sensor means 68 comprise an inductive sensor 68′ which detects inductively detectable foreign bodies in the production material 70 (indicated only once for better clarity) as soon as they reach the detection area of said inductive sensor.

In the production system 64 shown in FIG. 11, the production material 70 is transported by means of a conveyor belt 62″ between the production stations 74, 76, 78 to finally be supplied to a packing station 80, where the production material 70 is made ready for storage or transport there as a bundle.

A foreign body in the production material 70 is, for example and in particular, a label support 2 according to the invention or a fragment thereof which, however, are detected as such by the invention.

If the detection unit detects such a foreign body in the production material 70, a reject means 84 is actuated to reject either the production material 70 together with the foreign body or, optionally, only the foreign body, and thus separate it from the contamination-free production material 70. In this exemplary embodiment, the reject means 84 have a gripper 86 which moves for rejection purposes and grabs the contaminated production material 70 and removes it from the rest of the production material 70.

The invention shows its advantages in many forms and possible uses, of which the foregoing are only examples. The invention is thus not limited to the configurations and features described and shown. In this respect, the features can also be used in isolation from the exemplary embodiments or configurations in a different configuration according to the invention and are therefore not bound to the configurations shown and described, but can also be used in each case independently thereof as well as by way of example.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of reference signs

| | |
|---|---|
| Label support | 2 |
| Holding body | 4 |
| Label | 6 |
| Print | 6′ |
| Printed adhesive label | 6″ |
| Object to be labeled | 8 |
| Transparent section | 10 |
| Coating | 10′ |
| Contactlessly detectable | 12 |
| plastic | |
| Upper part | 14 |
| Lower part | 16 |
| A side, facing | 20 |
| the lower part 16, of the upper part 14 | |
| (Transparent) region of the upper part | 22 |
| View window | 22′ |
| Adhesive means | 24 |
| Adhesive strip | 24′ |
| A side, facing the upper part 14, of the | 26 |
| lower part 16 | |
| Plate-like elements for forming the | 28, 28′ |
| upper/lower part | |
| Film body | 30 |
| Extruded body | 32 |
| Underside | 34 |
| A side facing the object to be labeled | 34′ |
| Cylindrical object to be labeled | 36 |
| Tube | 36′ |
| Cable | 36″ |
| Container | 36″′ |
| Body axis | 38 |
| Free end of the object 36 | 40 |
| Interior of the object to be labeled | 42 |
| Holding means | 44 |
| Screws | 44′ |
| Adhesive means | 44″ |
| Adhesive layer | 44″′ |
| Region of the upper part 14 in which the | 46 |
| label 6 is arranged | |
| A side, facing away from the object 36, of | 48 |
| the upper part 14/holding body 4 | |
| Label element | 50 |
| Adhesive label | 50′ |
| Free end of the holding body 4 | 52 |
| Further free end of the holding body 4 | 54 |
| Overlapping section | 56 |
| Connecting section | 58 |
| Folding line | 60 |
| Groove | 61 |
| Production means | 62 |
| Production machine | 62′ |
| Conveyor belt | 62″ |
| Production system | 64 |
| Detection unit | 66 |
| Sensor means | 68 |
| Inductive sensor | 68′ |
| Production material | 70 |
| Production stations | 74, 76, 78 |
| Packing station | 80 |
| Reject means | 84 |
| Gripper | 86 |
| Circumferential direction | U |

1. A label support, comprising:
a holding body configured to hold a label, which is arranged thereon, on an object to be labeled,
the holding body comprising at least one transparent section configured to arrange a label,
wherein
the at least one transparent section comprises a plastic that contactlessly detectable in an inductive manner.

2. The label support of claim 1, wherein the at least one transparent section forms a layer of the holding body at least in regions.

3. The label support of claim 1, wherein the holding body has a lower part and an, in an installed state, an upper part arranged thereon, and
wherein the at least one transparent section is arranged on the upper part and/or lower part.

4. The label support of claim 3, wherein the upper part and/or the lower part or the at least one transparent section is configured to attach a print with the label.

5. The label support of claim 3, wherein the holding body is configured such that a label element of the label, in an installed state, is arrangeable or is arranged between the upper part and the lower part.

6. The label support of claim 1, wherein the contactlessly detectable plastic comprises an electrically-conductive plastic.

7. The label support of claim 6, wherein the electrically-conductive plastic comprises an intrinsically-conductive polymer.

8. The label support of claim 6, wherein the electrically-conductive plastic comprises an electrically-conductive additive.

9. The label support of claim 8, wherein the conductive additive comprises at least one of:
indium tin oxide,
fluorine tin oxide,
aluminum zinc oxide,
antimony tin oxide.

10. The label support of claim 5, wherein the conductive additive is distributed uniformly and homogeneously in the at least one transparent section.

11. The label support of claim 5, wherein the electrically-conductive plastic comprises at least one of:
polyacetylene,
polyaniline,
polyparaphenylene,
polypyrrole,
poly thiophene,
PEDOT:PSS.

12. The label support of claim 1, wherein the holding body comprises, uniformly, an electrically-conductive plastic.

13. The label support of claim 1, wherein the holding body is configured such that the holding body is releasably held in a holding state by holding means on the object to be labeled.

14. The label support of claim 1, wherein an adhesive means is arranged as a holding means at least on a side, facing, in a holding state, the object to be labeled, of the holding body, by which adhesive means the holding body adheres to the object to be labeled and held thereon in a material-bonded manner.

15. The label support of claim 1, wherein the label is printed at least partially on the at least one transparent section on a side, facing, in a holding state, the object to be labeled, of an upper part and/or of a lower part of the holding body.

16. The label support of claim 1, wherein the label comprises, at least partially, a laser label in an interior of the at least one transparent section.

17. The label support of claim 2, wherein an upper part of the holding body, in an installed state, completely covers the label at least in sections.

18. The label support of claim 2, wherein the at least one transparent section extends along an upper part of the holding body.

19. The label support of claim 2, wherein the holding body is configured such that an upper part thereof and a lower part thereof are separable from one another in a non-destructive manner.

20. The label support of claim 2, wherein an upper part and a lower part of the holding body are integrally connected to one another in an installed state.

21. The label support of claim 2, wherein an upper part and/or a lower part of the holding body comprise a multilayer film body.

22. The label support of claim 2, wherein an upper part and a lower part of the holding body are integrally connected to one another in a connecting section.

23. The label support of claim 22, wherein at least one straight, folding line is formed on the connecting section, along which folding line the upper part and the lower part are foldable relative to one another such that the upper part covers the lower part at least in sections in a folded state.

24. The label support of claim 20, wherein the holding body is configured for circumferential wrapping of a cylindrical object to be labeled, the cylindrical object comprising a cable, a hose, a tube, or a rod.

25. The label support of claim 20, wherein an extension of the upper part and of the lower part in a direction of arrangement in which the upper part and the lower part are arranged side by side is dimensioned such that, in a holding state in which the holding body is arranged on the object to be labeled, a free end of the holding body overlaps another free end of the holding body at least in sections in an overlapping section.

26. A production means, comprising:
a cylindrical body; and
the label support of claim 1 attached to the cylindrical body.

27. A production system, comprising:
the production means of claim 26; and
a detection unit configured to detect the label support and fragments of the label support by a sensor means.
